(19) United States
(12) Patent Application Publication
(10) Pub. No.: US 2017/0149967 A1
(43) Pub. Date: May 25, 2017

(54) Managing Communication Events

(71) Applicant: Microsoft Technology Licensing, LLC, Redmond, WA (US)

(72) Inventors: Vijay Chandrasekaran, Sunnyvale, CA (US); Nicholas Mark Cordrey, Redmond, WA (US)

(21) Appl. No.: 14/993,967

(22) Filed: Jan. 12, 2016

Related U.S. Application Data
(60) Provisional application No. 62/260,122, filed on Nov. 25, 2015.

(51) Int. Cl. H04M 3/42; H04W 4/16

(52) U.S. Cl. CPC H04M 3/42374; H04W 4/16

(57) ABSTRACT

A method for managing and communicating network characteristic presence status information between user terminals, the method comprising: determining network characteristic presence status information associated with a first user terminal based on the receipt or absence of a network characteristic presence status update message; and communicating the network characteristic presence status information associated with a first user terminal to at least one further user terminal, such that the at least one further user terminal indicates the current network characteristic presence status associated with the first user terminal.

### RELATED APPLICATION

This application claims priority under 35 U.S.C. §119 to provisional application No. 62/260,122, titled “Managing Communication Events” and filed on Nov. 25, 2015, the entire disclosure of which is incorporated by reference herein.

### BACKGROUND

Some communication systems allow the user of a device, such as a personal computer, to conduct voice or video calls over a packet-based computer network such as the Internet as well as conventional circuit switched networks such as GSM and PSTN communication networks. Such communication systems include voice or video over internet protocol (VoIP) systems. These VoIP systems are beneficial to the user as they are often of significantly lower cost to use than the conventional fixed line (PSTN) or mobile cellular (GSM) networks. This may particularly be the case for long-distance communication. To use a VoIP system, the user installs and executes client software on their device. The client software sets up the VoIP connections as well as providing other functions such as registration and authentication. In addition to voice communication, the client may also set up connections for other communication media such as instant messaging (“IM”), SMS messaging, file transfer and voicemail.

With increasing mobile bandwidths, there is increasing interest in providing packet-based voice and video calls via client applications running on user terminals such as Internet-enabled mobile phones. These user terminals comprise network interfaces 224 such as short-range RF transceivers operating on one or more unlicensed bands for accessing the Internet via wireless access points (e.g. of Wi-Fi access points of WLAN networks), and/or cellular transceivers operating on one or more licensed bands for accessing the Internet via a packet-based service of a cellular network such as GPRS (General Packet Radio Service) or HSPA (High Speed Packet Access).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Nor is the claimed subject matter limited to implementations that solve any or all of the disadvantages noted in the background section.

Embodiments of the present disclosure relate to management of communication events between first and second user terminals. In particular embodiments of the present disclosure relate to management of communication events using a communication client application (or communication client app). ‘Using’ a communication client application the user may dial a number or select a suitable contact to place an outgoing call. The call may be placed from the communication client app. The communication client app in such embodiments subscribes to call and dial events. When a number is dialled, or called, the communication client app may be able to place a call over different types of network depending on the available networks for both the caller and the callee. Placing a call over one type of network may have an associated cost, both financial and in terms of device resource (power, processor capacity) and as such the caller may wish to know when the callee is on a specific network or network type before placing the call in order to prevent placing the call over an unacceptable cost network. For example the caller may wish to know or be informed when a callee's user terminal is able to communicate over a cellular [2G, 3G or 4G] data link or other [WiFi] network and so be able to place a call over a network with a better quality call or over a network with no associated financial cost.

In some embodiments a user terminal is provided with the option to inform a selected group of further user terminals which type of network is currently accessible by the user terminal. In other words informing further user terminals of the user terminal network presence. This network characteristic presence information may be displayed on the further user terminal. Furthermore the network characteristic presence information may enable the user of the further terminal to make an informed decision of whether to place a call from the further user terminal to the user terminal.

Implementations provide a number of benefits for managing the placement of calls and communication events in such a manner may be significant, especially for user terminals with limitations with respect to network connectivity and processor power consumption.

In one aspect there is a communications server, the communications server comprising a network characteristic presence service application for managing and communicating network characteristic presence status information with at least one user terminal, the network characteristic presence service application being configured to: determine network characteristic presence status information associated with a first user terminal based on the receipt or absence of a network characteristic presence status update message; and communicate the network characteristic presence status information associated with a first user terminal to at least one further user terminal, such that the at least one further user terminal indicates the current network characteristic presence status associated with the first user terminal.

In another aspect there is a user terminal, the user terminal comprising a communication client application for managing and communicating network characteristic presence status information with at least one further user terminal, the communication client application being configured to: generate a network characteristic presence status update message comprising a user terminal access data network identity as network characteristic presence status information associated with the user terminal; transmit the network characteristic presence status update message to a communications server such that the communications server is configured to communicate the network characteristic presence status information associated with the user terminal to at least one further user terminal.

In a further aspect there is a user terminal, the user terminal comprising a communication client application for managing and communicating network characteristic presence status information from at least one further user terminal, the communication client application being configured to: receive presence status information associated with at least one further user terminal; and generate an interrupt message based on the presence status information so to indicate the current network characteristic presence status associated with the at least one further user terminal.

There is a another aspect there is a method for managing and communicating network characteristic presence status information between user terminals, the method comprising: determining network characteristic presence status information associated with a first user terminal based on the receipt or absence of a network characteristic presence status update message; and communicating the network characteristic presence status information associated with a first user terminal to at least one further user terminal, such that the at least one further user terminal indicates the current network characteristic presence status associated with the first user terminal.

A further aspect is a method for managing and communicating network characteristic presence status information between user terminals, the method comprising: generating a network characteristic presence status update message comprising a user terminal access data network identity as network characteristic presence status information associated with the user terminal; and transmitting the network characteristic presence status update message, wherein the message is configured to communicate the network characteristic presence status information associated with the user terminal to at least one further user terminal.

Another aspect is a method for managing and communicating network characteristic presence status information between user terminals, the method comprising: receiving at a first user terminal presence status information associated with at least one further user terminal; and generating an interrupt message based on the presence status information so to indicate the current network characteristic presence status associated with the at least one further user terminal.

### BRIEF DESCRIPTION OF THE DRAWINGS

For a better understanding of the present disclosure and to show how it may be put into effect, reference is now made by way of example to the accompanying drawings in which:

FIG. 1a is a schematic representation of a communication system,

FIG. 1b is a further schematic representation of the communication system with a distributed platform communications server,

FIG. 1c is a schematic representation of a distributed platform communications server such as shown in FIG. 1b in further detail,

FIG. 2 is a schematic block diagram of a mobile terminal,

FIG. 3 is an example flow diagram of a summary of the network characteristic presence information control and management operation,

FIG. 4 is an example flow diagram of network characteristic presence information initialisation operation,

FIG. 5 is an example flow diagram of network characteristic presence status push and network characteristic presence employment operation,

FIG. 6 is an example flow diagram of network characteristic presence information communication over a PSTN network,

FIGS. 7a to 7c are example UI messages with respect to some embodiments, and

FIGS. 8a to 8d are further examples of network characteristic presence information control and management with respect to some embodiments.

### DETAILED DESCRIPTION

Embodiments of the present disclosure are described by way of example only.

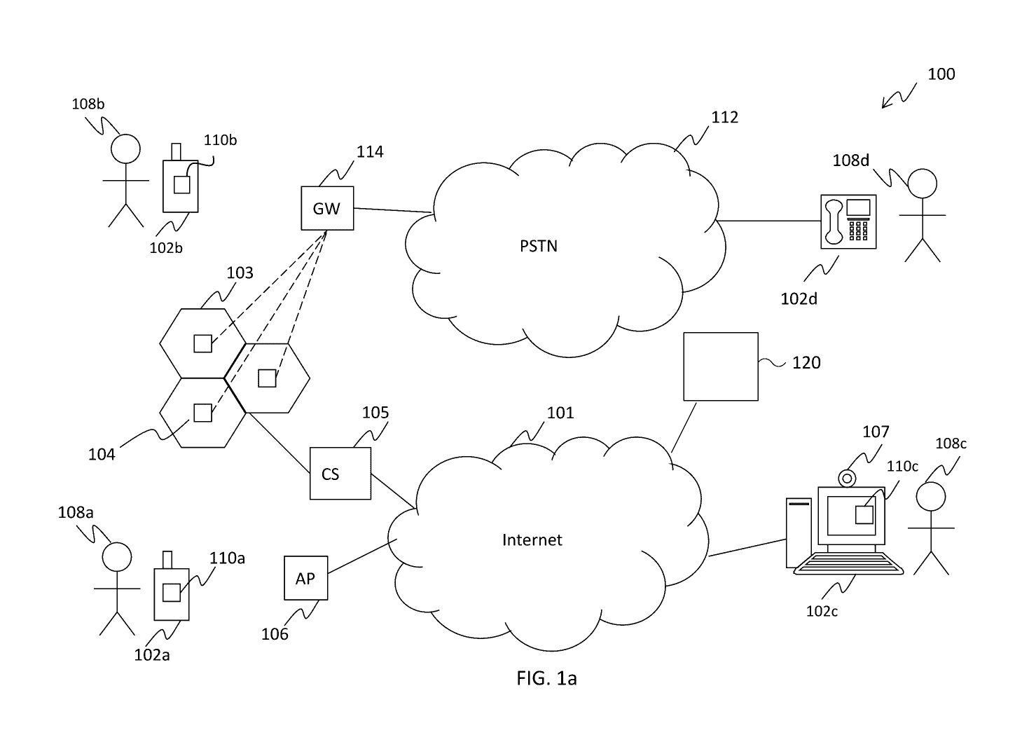

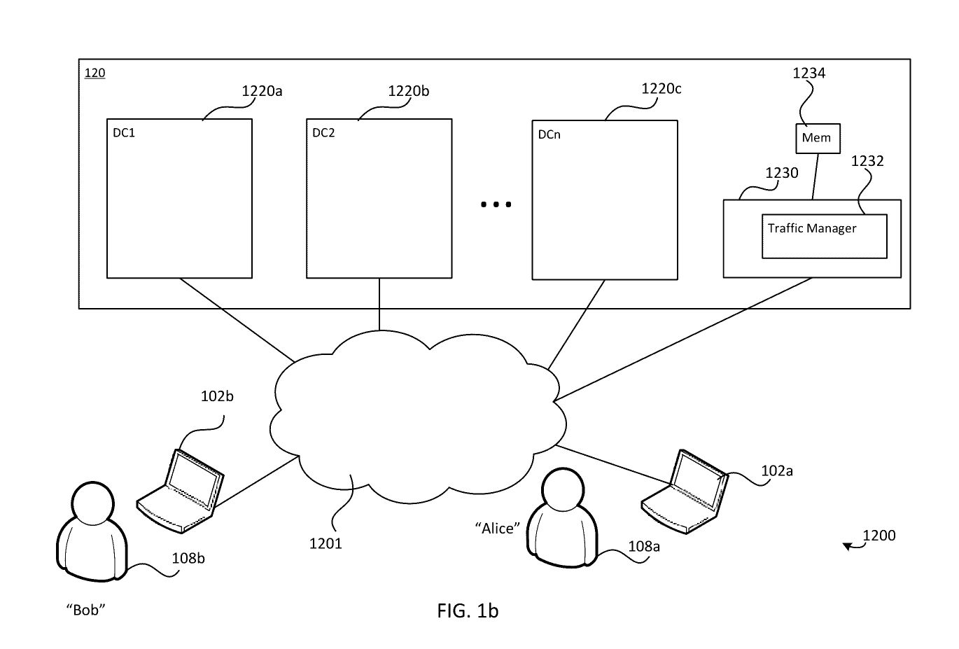

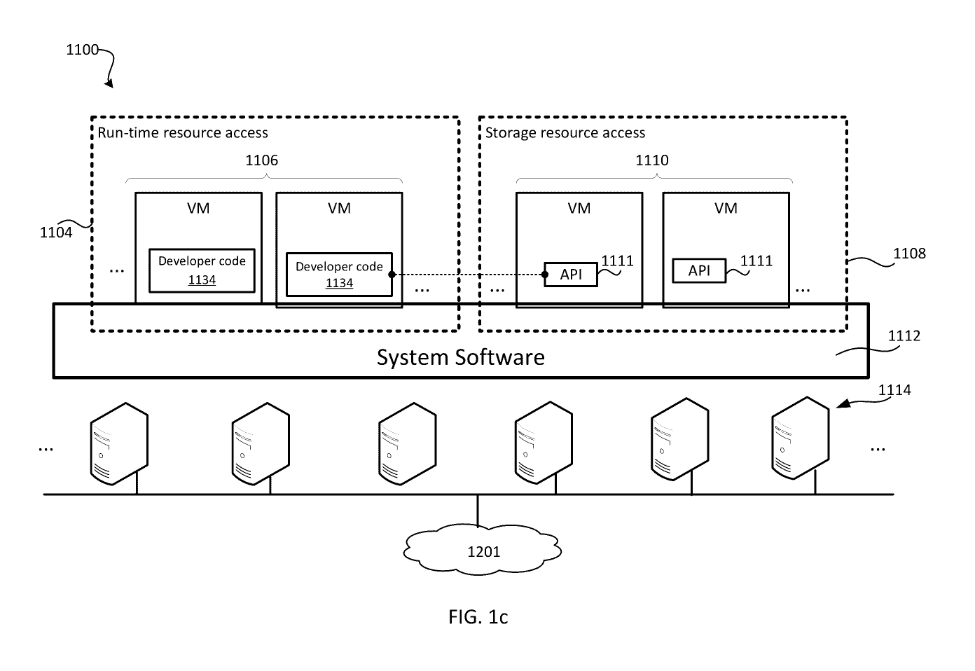

FIG. 1 is a schematic illustration of a communication system 100 comprising a packet-based network 101 such as the Internet, a mobile cellular network 103, and a circuit switched network 112 such as the public switched telephone network (PSTN). The mobile cellular network 103 comprises a plurality of base stations 104 (sometimes referred to as node Bs in 3GPP terminology). Each base station 104 is arranged to serve a corresponding cell of the cellular network 103. Each base station 104 is connected to the circuit switched network 112 via a gateway 114. Further, the packet-switched network 101 comprises a plurality of wireless access points 106 such as Wi-Fi access points for accessing the Internet. These may be the access points of one or more wireless local area networks (WLANs).

A plurality of user terminals 102 (or user devices) are arranged to communicate over one or more of the networks 101, 103, 112. For merely illustration purposes only, FIG. 1 shows user terminal 102a as an Internet-enabled mobile device, user terminal 102c as a desktop or laptop PC, user terminal 102b as a cellular mobile phone 102b, and user terminal 102d as a landline telephone connected to the circuit switched network 112.

The communications between user terminals 102 may be managed and controlled via a communications server 120. The communications server 120 may receive requests from a user terminal to place a call to a further user terminal. The communications server 120 may then communicate with the further user terminal and place the call by routing communications via an available network for the further user terminal. Furthermore the communications server 120 may be configured to forward network characteristic presence information associated with a user terminal to other or further user terminals.

FIG. 1b shows an example simplified communication system 1200 within which the communications server 120 may be employed. The communication system 1200 includes a combined network 1201. The combined network 1201 may be considered to be a combination of the various access and core networks described herein. Connected to the combined network 1200 are the user terminals (also referred to as user devices or client device) 102a which in FIG. 1b is associated with a first user 108a (“Alice”) and a further user terminal 102b which in FIG. 1b is associated with a second user 108b (“Bob”). The user terminals 102a, 102b are endpoints of the combined network 1201. The user terminals 102a, 102b are arranged to receive information from and output information to the relevant user. Although only two user terminals are shown in FIG. 1b, many more user terminals may be included in communication system 1200. Each user terminal may be a computer device which as discussed herein can take a number of forms e.g. that of a desktop or laptop computer, mobile phone (e.g. smartphone), tablet computing device, wearable computing device, television (e.g. smart TV), set-top box, gaming console etc.

Also connected to network 1201 are a plurality of data centres (DCs) 1220a, 1220b, . . . , 1220c and a traffic management system 1230. The traffic management system 1230 comprises one or more memory devices 1234 and one or more processors configured to execute traffic management code 1232 (traffic manager/traffic management logic) for managing datacentre traffic. The traffic management system 1230 and the datacentres 1220 form part of a distributed platform implementations of the communications server 120.

Thus the communications server 120 in some embodiments may be implemented according to a distributed computing architecture platform.

A high-level overview of an exemplary distributed platform 1100 is shown in FIG. 1c. The exemplary platform includes a distributed computer system 1114. The computer system 1114 of FIG. 1c is comprised of a very large number (e.g. tens of thousands) of networked computer devices—large enough that the physical computing resources can, in some contexts, be considered sufficiently plentiful as to be effectively unlimited. These computer devices are configured for communication with the combined network 1201 (of which a part is a packet-based network, e.g. the Internet) and are globally distributed (e.g. spread across multiple countries and/or continents). Typically, groups of such computer systems (e.g. thousands of servers) are housed in respective data centres (datacentre) at different geo-locations (i.e. in different regions of a country, different countries, different continents etc.)

System software 1112 runs on top of the distributed computer system 1114. The system software 1112 is configured to implement two sets 1104 (runtime set) and 1108 (storage set) of independent, virtual machines 1106, 1110.

The runtime set 1104 comprises multiple VMs 1106 which provide runtime environments for execution of application code 1134, the application code 1134 being executed on that virtual computer system 1106. The system software 1112 is configured to enable a software developer, desiring to make use of the platform 1100, to upload their bespoke code 1134 via the network 1201 to the platform 1100 for execution thereon. In response, the system software 1112 creates such a runtime environment and supplies the code 1134 to the newly-created runtime environment for execution. Execution of this code 1134 on the virtual system 1106 is made possible by the system software mediating access to underlying physical processing resources and physical memory resources (primarily realized at the physical level by physical volatile memory) allocated to that environment.

The storage set 1108 comprises multiple virtual machines 1110 configured to provide data storage. Each has a corresponding Application Programming Interface (API) 1111 which can be used to effect transfer of data to and from the physical memory resources (primarily realized at the physical level by physical non-volatile memory) allocated to that computer system 1110 e.g. by code 1134 making suitable function calls thereto. This transfer is, again, mediated by the system software 1112.

Embodiments provide a system comprising computer storage which holds code configured to implement various types of controller. These include:

a call controller which handles high-level signalling functions, e.g. for establishing a communication event, e.g. call between two or more users, and for high-level management of the established communication event, e.g. in-call management, such as adding/removing participants, adding/removing media modalities etc., and terminating the established communication event;

one or more a media (modality) controllers, each for managing a media modality of the established communication event; the media modality controllers control the flow of actual media content, under the control of the call controller, for instance by controlling the manner in which overlay network connections (e.g. peer-to-peer and/or relayed connections) are established between participating endpoints; media modalities include audio, video, screen sharing, shared whiteboard etc. In some embodiments, the media modality service is only delivered for group calls (between three or more users).

An instance of a controller is implemented by application code executed on one more VMs of the cloud platform.

That is, a Call Controller (CC) may be a server entity responsible for call setup & management of two-party calls, and helps with multi-party call setup & management as well. In some embodiments the call controller and the server entity may be implemented within the user terminals. In other words, in some embodiments, the communications server functionality may be implemented at least partially within a user terminal.

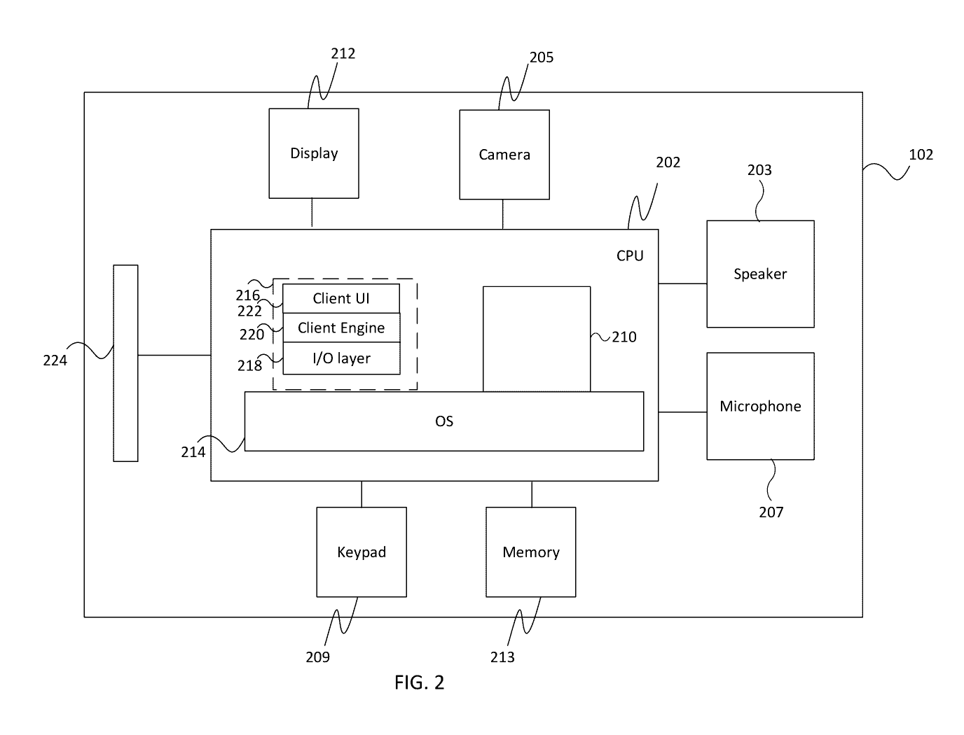

An example user terminal 102a is shown schematically in FIG. 2. The user terminal 102a as described herein may be one of an Internet-enabled mobile telephone; a handheld game console; a personal digital assistant (PDA); a tablet computer; or a laptop computer.

The user terminal 102a comprises a processing apparatus in the form of one or more processor units (CPUs) 202 coupled to a memory 213 storing a communication client application (or communication client app). The processor 202 is also coupled to: a microphone 207, a speaker 203, camera 205, one or more network interfaces 224, a keypad 209, and a display 212.

In the example shown in FIG. 2, the microphone 207, speaker 203, camera 205, keypad 209, and display 212 are examples of suitable user interface inputs and outputs. In some embodiments the user interface input may be a keyboard, mouse, pointing device, touchpad or any suitable user interface input device, for example gesture or motion control user input, head-tracking or eye-tracking user input, a ‘touch’ or ‘proximity’ detecting input configured to determine the proximity of the user to the display 212 (in other words a touch or hover touch interface).

The one or more network interfaces 224 enable the user terminal 102a to access the one or more networks 101, 103, 112. For example, user terminal 102a may comprise a cellular wireless transceiver for accessing the mobile cellular network 103 via the base stations (or cellular network access point) 104, and/or a wired or wireless modem for accessing the Internet 101. In the case of a wireless modem, this typically comprises a short-range wireless transceiver (e.g. Wi-Fi) for accessing the Internet 101 via the wireless access points 106.

Access to the Internet 101 may also be achieved by other means such as GPRS (General Packet Radio Service) or HSPA (High Speed Packet Access). At a higher level of the cellular hierarchy, the cellular network 103 comprises a plurality of cellular controller stations 105 each coupled to a plurality of the base stations 104. The controller stations 105 are coupled to a traditional circuit-switched portion of the mobile cellular network 103 but also to the Internet 101. The controller stations 105 are thus arranged to allow access to packet-based communications via the base stations 104, including access to the Internet 101. The controller stations 105 may be referred to for example as Base Station Controllers (BSCs) in GSM/EDGE terminology or Radio Network Controllers (RNCs) in USTM or HSPA terminology.

The memory 213 may comprise a non-volatile memory such as an electronic erasable and programmable memory (EEPROM, or “flash” memory) coupled to the processor 202. The memory stores communications code arranged to be executed on the processor, and configured so as when executed to engage in communications over one or more networks 101, 103, 112. The communications code preferably comprises a communication client application 110a provided by a software provider associated with the communication system. The communication client application 110a may be executed for performing communications such as voice or video calls with other user terminals 102 over the Internet 101, via a network interface 224 and wireless access points 106, and/or via the network interface 224, base stations 104 and controller stations 105 of the cellular network 103 as discussed above. However, one or more of the user terminals 102 involved could alternatively communicate via the network interface 224 and a wired modem, e.g. in the case of a call between a mobile terminal and a desktop PC.

The CPU 202 is connected to the network interface 224 such as a modem for communication with the communication networks. The network interface 224 may be integrated into the user terminal 102 as shown in FIG. 2. In alternative user terminals the network interface 224 is not integrated into the user terminal 102. The network interface 224 may comprise a short-range wireless transceiver for communication to the wireless access points or a cellular transceiver for communication to the base stations.

As shown in FIGS. 1a and 1b both user terminals 102a and 102b execute communication client application software 110 in order for the user terminals 102a and 102b to transmit and receive data over the Internet 101. In other words the communication client application may be used to initiate packet based communication with another communication client application associated with the same communication network (for example an overlay network and distinct from the communication system 100). The communication client application may for example be configured to transmit and receive data associated with a defined communication protocol to define the network. For example the communication client application may be configured to communicate with other communication client applications executed on further user terminals using a Voice over Internet Protocol (VoIP) protocol. It is understood that in some embodiments a user terminal comprises some other communication client software, for example communication client software able to communicate over only one of the communication networks. The communication client application 110 may be downloaded and installed from a remote server. Furthermore in some embodiments the communication client application 110 when first installed or executed may be configured to contact and register the installation or execution of the communication client application at a communication client application database. The communication client application database may comprise parts which are locally cached on the user terminal 102, or remote from the user terminal (for example on a server or over a distributed computing system). Furthermore in some embodiments the communication client application is configured to communicate with a communications server configured to handle and direct communications to further communication client applications operating on other user terminals.

FIG. 2 also illustrates an operating system (“OS”) 214 executed on the CPU 202. Running on top of the OS 214 is a software stack 216 for the communication client application (CCA) 110a. The software stack shows a client protocol layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 214 manages the hardware resources of the device 102a and handles the transmission and receipt of data via the network interface 207. The client protocol layer 218 of the communication client app communicates with the operating system 214 and manages the connections over the communication system. Processes requiring higher level processing are passed to the client engine layer 220. The client engine 220 also communicates with the client user interface layer 222. The client engine 220 may be arranged to control the client user interface layer 222 to present information to the user 108a via the user interface of the client and to receive information from the user 108a via the user interface.

Also shown in FIG. 2 is a communication client application 210. The communication client application may be a native communication client (the communication client provided with the device from the factory. The communication client application may thus be executed for performing communications such as voice or video calls with other user terminals 102 over the network interface 224, base stations 104 and controller stations 105 of the cellular network 103 as discussed above.

The following examples describe the setting up, determination and use of network characteristic presence information, for example within a communication client application 110/210 in order to control the setting up and communicating of a call.

As described herein a communication client application operating on a user terminal may be able to make or place a call while operating on a WiFi or cellular network. The communication client will have visibility with respect to the currently available data networks and furthermore knowledge of potential costs (both resource and financial) incurred by placing a call from the user terminal to the communications server. In other words the user terminal may have full network characteristic presence visibility for the network path from the user terminal to the server.

Furthermore the user terminal may have status presence information informing the user terminal of the status of the further terminal. In other words whether the further terminal is ‘online’, ‘away’, ‘invisible’ etc. However the user terminal does not have network characteristic presence visibility for the further terminal. Thus for example placing a call from the user terminal may be free (in terms of financial cost) as the user terminal is either connected via a free access point (such as a free WiFi data network), or has metered or unmetered free data (on a cellular data network). However placing the call may not be free where the access point used by the further user terminal has associated costs. For example where the further user terminal is accessing the communications server via a charged cellular data network.

By providing user terminal network characteristic presence information to other user terminals and furthermore selectively providing this information, it is possible to provide this information to the user of the user terminal and thus enable the user to make an informed decision on placing or not placing a call.

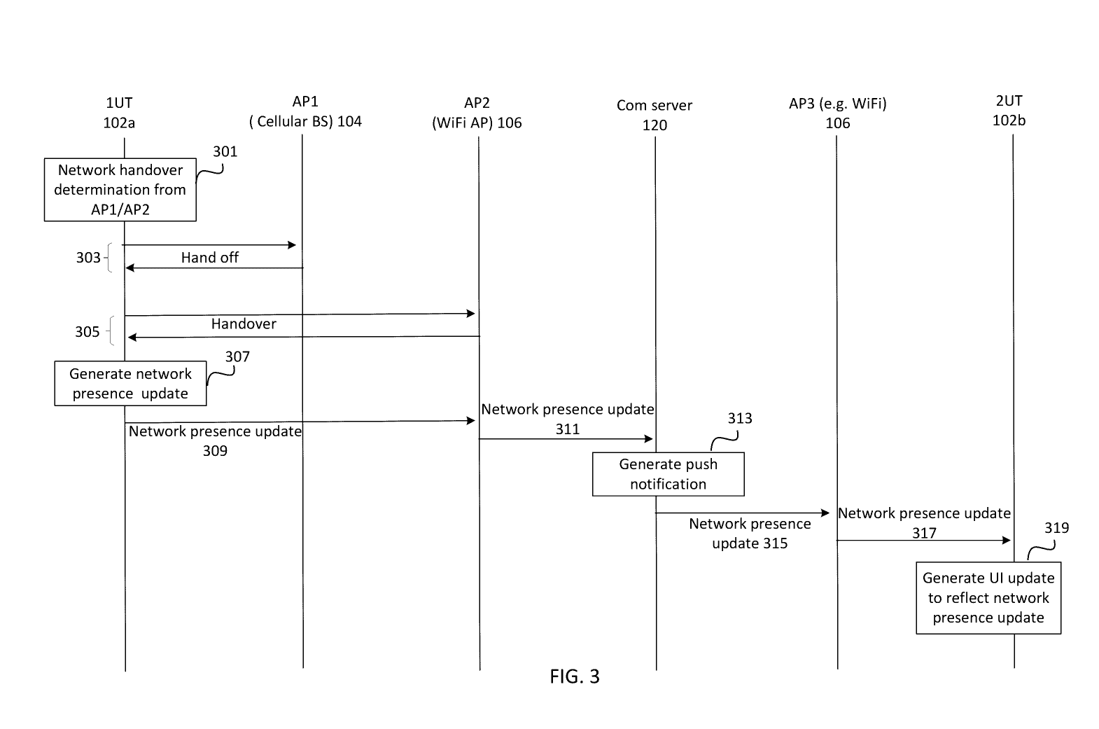

With respect to FIG. 3 a flow diagram of the network characteristic presence information control and management operation is shown. The network characteristic presence information control and management operation in some embodiments may enable the sharing or transfer of real-time or ‘near real-time’ network characteristic presence status information from a user terminal to a communications server and/or other user terminals.

The example shown in FIG. 3 shows a sequence which starts when the user terminal 102a performs a handover between a first access point AP1 such as a cellular base station 104 to a second access point AP2 such as the WiFi access point 106. This handover is the trigger for generating a network characteristic presence status update message to be sent to the communications server 120.

However it is understood that in some embodiments a physical or logical handoff need not be the trigger for the generation of a network characteristic presence status update message. For example in some embodiments the trigger may be the determination of a preferred or ‘better’ network. Thus for example the user terminal may store a list (or ranked list) of preferred networks or network types and select the preferred access network when it is detected. Similarly in some embodiments the user terminal determines a preference value based on at least one of network type, network quality, network speed and when detecting a new network determines whether the new network has a higher value and if so triggers the generation of a network characteristic presence status update message. In some embodiments the trigger for generating a network characteristic presence status update message may be one of time. In other words a network characteristic presence status update message may be generated in some embodiments at a determined time or a determined time period since the last generated message (for example 20 minutes).

Thus in some embodiments the user terminal 102a determines that there is to be a handover from a first access point AP1 104 to a second access point AP2 106. This handover determination may be based on any suitable handover trigger event. In some embodiments the trigger may be a measurement made in the user terminal 102a such as the signal strength of the first access point AP1 104 is below a determined threshold and/or the signal strength of the second access point AP2 106 being above a determined threshold.

Furthermore the handover trigger may be based on receiving a message from an access point. For example the first access point AP1 104 determining that there is poor quality signals from the user terminal.

The operation of determining a network handover is shown in FIG. 3 by step 301.

The user terminal may then communicate with the first access point AP1 104 to perform a handoff process.

The operation of performing a handoff process between the user terminal 102a and the first access point AP1 104 is shown in FIG. 3 by step 303.

The user terminal may then communicate with the second access point AP2 106 to perform a handover process.

The operation of performing a handover process between the user terminal 102a and the second access point AP2 106 is shown in FIG. 3 by step 305.

The user terminal may then generate a network characteristic presence status update message. The network characteristic presence status update message in some embodiments comprises information identifying the ‘new’ network which can be used to communicate between the user terminal 102a and the communications server 120. Furthermore in some embodiments the network characteristic presence status update message may comprise a distribution list identifying which further user terminals are to receive this information.

The operation of generating the network characteristic presence status update message is shown in FIG. 3 by step 307.

The user terminal 102a may then transmit the network characteristic presence status update message via the second access point AP2 106 to the communications server 120.

The operation of transmitting the network characteristic presence status update message from the user terminal 102a to the second access point AP2 106 is shown in FIG. 3 by step 309.

The operation of forwarding the network characteristic presence status update message from the second access point AP2 106 to the communications server 120 is shown in FIG. 3 by step 311.

The communications server 120, having received the network characteristic presence status update message may then be configured to generate a push message which may be transmitted to a determined list of further user terminals. The push message may comprise information identifying the network for the user terminal. For example the information may identify the ‘type’ of the network, such as cellular or WiFi, or type of cellular data network (2G, 3G, 4G etc.). In some embodiments the information may identify whether it is a ‘free’ or ‘metered’ data network. In some embodiments the information may identify the quality of the network in terms of data speed and/or data latency and/or data transmission loss or error.

The determined list of further user terminals, to determine where the push message is to be transmitted, may be based on the information within the network characteristic presence status update message. The determined list in some embodiments may be generated from information stored in a database associated with the communications server. In some embodiments the determined list may be generated from the recent call list (either incoming or outgoing) associated with the user terminal. In some embodiments the determined list may be generated from the user terminal ‘speed dial’ list, or from the user terminals ‘favourite’ list.

The operation of generating a network characteristic presence status push message is shown in FIG. 3 by step 313.

The communications server 120 may then pass the network characteristic presence status push message to the access point(s) associated with the further user terminals. For example with respect to FIG. 3 a single further user terminal 102b is shown which is accessible by the access point AP3. It is understood that the access point AP3 may in practice be the first access point AP1 104 or second access point AP2 106. In this example the access point AP3 is also the WiFi access point 106.

The operation of forwarding the network characteristic presence status push message from the communications server 120 to the access point AP3 106 is shown in FIG. 3 by step 315.

The access point then transmits the network characteristic presence status push message to the further user terminal 102b.

The operation of transmitting the network characteristic presence status push message from the access point AP3 to the further user terminal 102b is shown in FIG. 3 by step 317.

The further user terminal may then process the network characteristic presence push message and in some embodiments generate a network characteristic presence interrupt message based on the push message.

The operation of generating a network characteristic presence UI (interrupt) message based on the push message is shown in FIG. 3 by step 319.

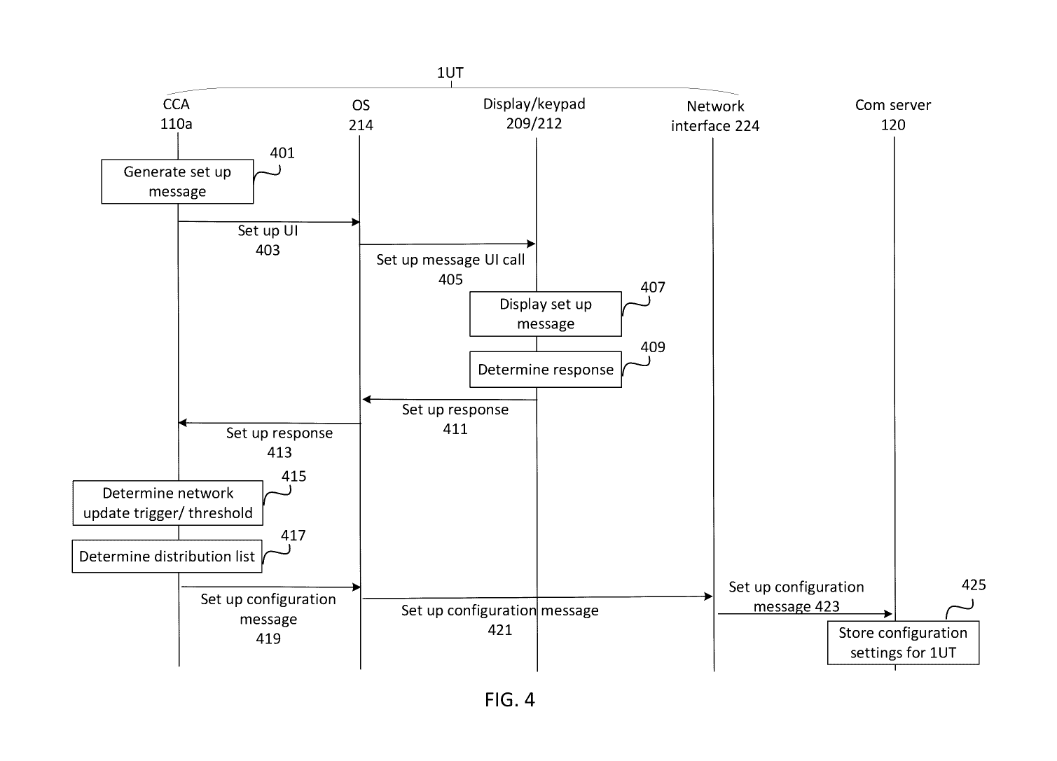

With respect to FIG. 4 a network characteristic presence initialisation operation is shown. The network characteristic presence initialisation operation may define the network characteristic presence status update message trigger events and/or define the push message distribution list.

The first user terminal (1UT) 102a, and the communication client application (CCA) 110a, in some embodiments may generate a network characteristic presence interrupt or setup message.

The operation of generating the network characteristic presence interrupt message is shown in FIG. 4 by step 401.

The network characteristic presence interrupt message may be forwarded from the CCA 110a to the operating system (OS) 214.

The operation of forwarding the interrupt message from the CCA to the OS is shown in FIG. 4 by step 403.

The OS 214 may then forward the interrupt message to the display 209.

The operation of forwarding the interrupt message from the OS to the display is shown in FIG. 4 by step 405.

The display 209 may then be configured to display a suitable network characteristic presence setup message based on the received interrupt message.

The operation of displaying the network characteristic presence setup message is shown in FIG. 4 by step 407.

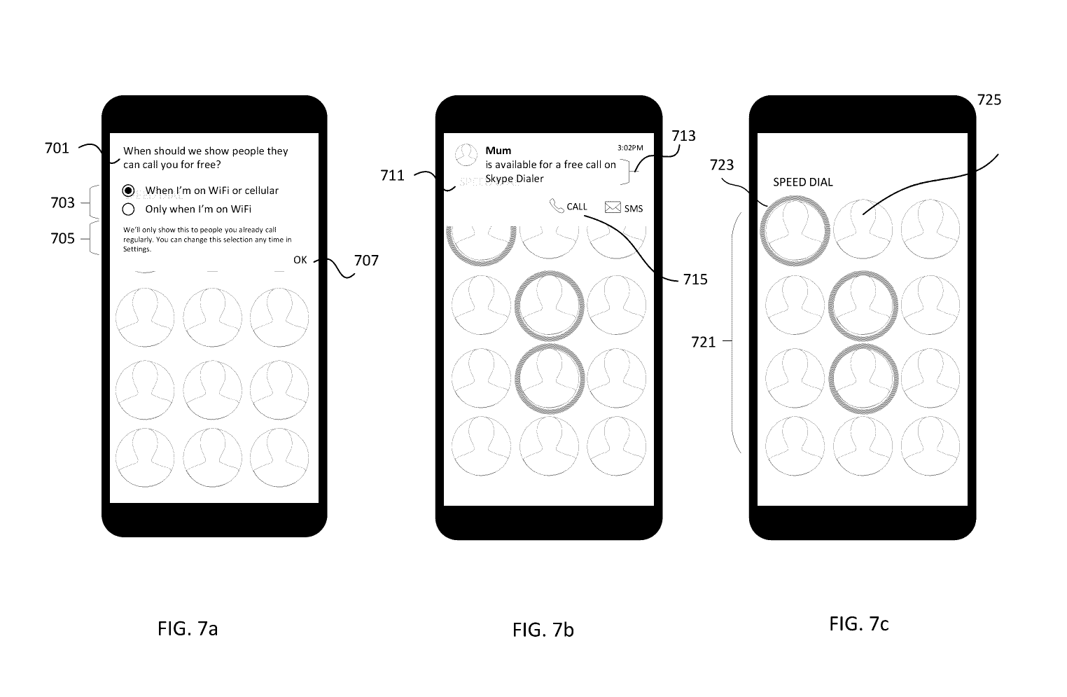

An example of a network characteristic presence setup message is shown in FIG. 7a. In FIG. 7a a user interface window message 701 is displayed to the user and overlays the current communication window. The window message 701 may comprise a series of inputs, such as radio buttons 703 to provide the user with options to define when the network characteristic presence status update messages are to be generated. For example FIG. 7a shows that the user is provided with the options of generating network characteristic presence status update messages when the user terminal is operating on a Wi-Fi or cellular network or only on a Wi-Fi network.

The user interface window message may further comprise text 705 to assist the user in making the decision.

Furthermore the user interface window message may comprise an ‘ok’ input button 707 or area to accept the inputs and in some embodiments to remove the pop-up message when read.

The UI window message shown in FIG. 7a is an example of an interrupt message which enables the user interface display to display a notification message which can be responded to. It is understood that in some embodiments the interrupt message may be any suitable user interface output or notification. For example the message may be an audio message and the input an audible response from the user.

The display/keypad (as an example of a suitable UI input) may be configured to generate a suitable setup response message based on the inputs from the user interface window message 701.

The operation of generating/determining a setup response is shown in FIG. 4 by step 409.

The setup response can be passed from the display/keypad to the operating system (OS) 214.

The operation of forwarding the response from the display/keypad to the OS 214 is shown in FIG. 4 by step 411.

Furthermore the OS 214 may be configured to forward the response message to the communication client application (CCA) 110a.

The operation of forwarding the set up a response from the OS 214 to the CCA 110a is shown in FIG. 4 by step 413.

The CCA 110a having received the response may then process the contents of this response.

Thus the response may define the generate network characteristic presence status update message trigger event or threshold.

The operation of determining the network update trigger threshold is shown in FIG. 4 by step 415.

Furthermore in some embodiments the CCA 110a may be configured within the setup operation to define the push message distribution list. This may furthermore be defined based on the user interface response. For example the user interface response may indicate whether the push message is to be passed to user terminals on the user terminal call history list, a favourites list, or some other defined list.

Thus the CCA 110a may determine a push message distribution list, in other words to define the addresses to send the push message to. In some embodiments the CCA 110a may determine the rules for determining the distribution list, in other words selecting the addresses from which list or lists.

The operation of determining the push message distribution list is shown in FIG. 4 by step 417.

In some embodiments the CCA 110a is configured to generate a network characteristic presence configuration message to be transmitted to the communications server 120. Thus for example the CCA 110a generates the configuration message, for example comprising the determined distribution list, and passes the message to the OS 214.

The operation of transmitting the configuration message from the CCA to the OS is shown in FIG. 4 by step 419.

The OS 214 can then forward the configuration message to the network interface 224.

The operation of forwarding the setup configuration message from the OS 214 to the network interface 224 is shown in FIG. 4 by step 421.

The network interface 224 can then forward the setup configuration message from the network interface to the communications server 120.

The operation of transmitting the configuration message from the network interface 224 to the communications server 120 is shown in FIG. 4 by step 423.

The communications server 120 having received the configuration message can be configured to store the configuration settings for the first user terminal. These configuration settings may for example be used to determine the distribution addresses when any network characteristic presence status update messages are received by the communications server 120 such as shown in FIG. 3.

The operation of storing the configuration settings for the first user terminal 102a is shown in FIG. 4 by step 425.

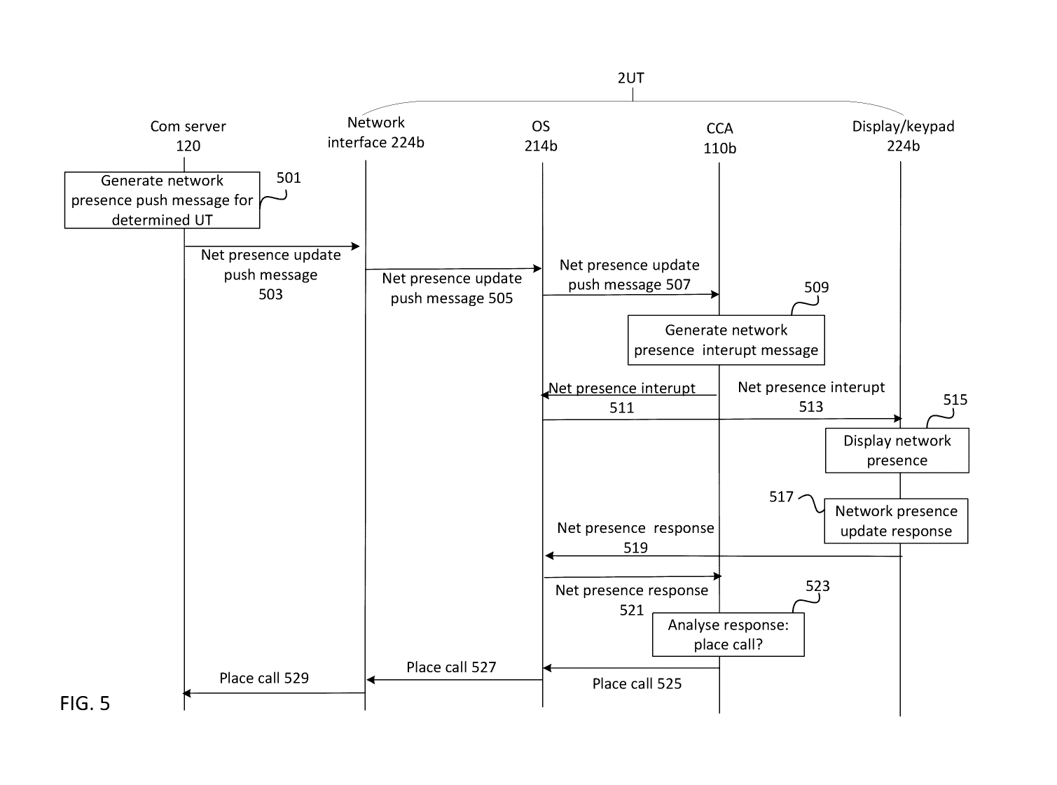

With respect to FIG. 5 an example flow diagram of a network characteristic presence status push and network characteristic presence employment operation is shown in further detail.

In the example shown in FIG. 5 the communications server 120 is configured to generate the network characteristic presence status push message for a selected or determined list of user terminals. In this example one of the selected user terminals is the second user terminal (2UT) 102b.

The operation of generating the network characteristic presence status push message is shown in FIG. 5 by step 501.

The communications server 120 is then configured to forward the network characteristic presence status push message to the user terminal and the network characteristic presence status push message is received at the network interface 224b.

The operation of forwarding the network characteristic presence status push message from the communications server to the network interface is shown in FIG. 5 by step 503.

The network interface 224b can then be configured to forward the network characteristic presence status push message to the operating system 214b.

The operation of forwarding the network characteristic presence status push message from the network interface 224b to the OS 214b is shown in FIG. 5 by step 505.

Furthermore the OS 214b can be configured to forward the network characteristic presence status push message to the client communication application 110b.

The operation of forwarding the network characteristic presence status push message from the OS 214b to the CCA 110b is shown in FIG. 5 by step 507.

In some embodiments the CCA 110b, having received the network characteristic presence status push message, is configured to generate a network characteristic presence interrupt message to be displayed. For example where the network characteristic presence status push message indicates that one of the members of the recently called list, favourites list or contacts list has changed network type then the CCA can be configured to generate a network characteristic presence interrupt message.

The operation of generating a network characteristic presence interrupt message based on the network characteristic presence status push message is shown in FIG. 5 by step 509.

The network characteristic presence interrupt message can then be forwarded from the CCA 110b to the OS 214b.

The operation of forwarding the network characteristic presence interrupt message from the CCA to the OS is shown in FIG. 5 by step 511.

The OS 214b can then forward the network characteristic presence interrupt message to the display 224b.

The operation of forwarding the network characteristic presence interrupt message from the OS to the display is shown in FIG. 5 by step 513.

The display may then be configured to display a network characteristic presence update on the display based on the network characteristic presence interrupt message.

The operation of displaying the network characteristic presence update is shown in FIG. 5 by step 515.

An example network characteristic presence update UI display is shown in FIGS. 7b and 7c.

With reference to FIG. 7b an example network characteristic presence update in the form of a window message 711 is shown. The window message 711 may overlay any underlying user interface element displayed, such as a dialler user interface as shown in FIG. 7b. In some embodiments the network characteristic presence update may be an operating system network characteristic presence update. The window message 711 may comprise text 713 indicating the user associated with the user terminal and the ‘new’ or updated network and/or network type and/or network operator based on the push message information. Furthermore in some embodiments the text 713 may indicate that the user associated with push message is available to call for free. The text 713 in FIG. 7b comprises the identity of the user ‘mum’ and the details of the cost of placing a call ‘is available for a free call on Skype dialler’.

Furthermore the windows message 711 may further comprise inputs such as a call button 715 enabling the user of the user terminal to directly place a call to the user terminal.

With regards to FIG. 7c a further network characteristic presence update is shown with respect to a dialler user interface. In this example the dialler user interface shows an array 721 of images 725 representing other users and associated user terminals. These users may for example be from the speed dial list, a recent received/called list (a call history list), or users on a contacts list.

Each of the images 725 representing a further user may be interacted with in order to place a call. Furthermore in some embodiments the network characteristic presence update may provide a ‘highlighting’ of the image. For example in some embodiments each image may be highlighted by a coloured ring 723 around the array element image 725. The coloured ring 723 may identify the network characteristic presence information associated with the user terminal. For example the colour of the ring may identify the network and/or network type and/or cost involved in calling that user identified by the image 725. Thus in some embodiments a coloured ring may identify when the user can be called for no cost. In some embodiments various colours or effects on the ring may identify the network and/or network type and/or cost involved in calling that person. For example a red ring may identify a poor quality network, a green ring for good quality network etc.

Although the examples here show the highlighting effect as a ring surrounding the displayed image any other suitable highlighting method may be employed. For example the image 725 may change from being a black and white (or monochrome) image of the user to a colour image of the user when the notification update indicates that the user has changed from a cellular to WiFi network.

In some embodiments of the display may be configured to receive and determine network characteristic presence update responses. For example in some embodiments the user of the user terminal can select one of the images 725 to place a call with another user when the highlighting ring indicates that a further user may be called for free.

The operation of determining a network characteristic presence response is shown in FIG. 5 by step 517.

The network characteristic presence response may then be passed from the display to the OS 214b.

The operation of passing the network characteristic presence response from the display to the OS is shown in FIG. 5 by step 519.

The OS 214 be then forward the network characteristic presence response to the CCA 110b.

The operation of forwarding the network characteristic presence response from the OS to the CCA is shown in FIG. 5 by step 521.

In some embodiments the CCA 110b is configured to analyse the network characteristic presence response and determine whether or not the response is to place a call with a person.

The operation of determining whether or not to place a call is shown in FIG. 5 by step 523.

The CCA 110b, having determined that a call is to be placed may generate a place call message and forward a place call message to the OS 214b.

The operation of generating a place call message and forwarding a place call message is shown in FIG. 5 by step 525.

The OS 214b can then forward the place call message to the network interface 224b.

The operation of forwarding the place call message from the OS 214b to the network interface 224b is shown in FIG. 5 by step 527.

The network interface 224b may then transmit the place call message to the communications server 120 in order to place the call.

The operation of forwarding at the place call message from the network interface to the communications server 120 is shown in FIG. 5 by step 529.

The communications server 120 may having received the place call message be configured to place the call using the available networks.

Although the examples shown above employ a push message to transfer the network characteristic presence status information in some embodiments, for example where the recipient has data switched off, the network characteristic presence information may be communicated over a PSTN network.

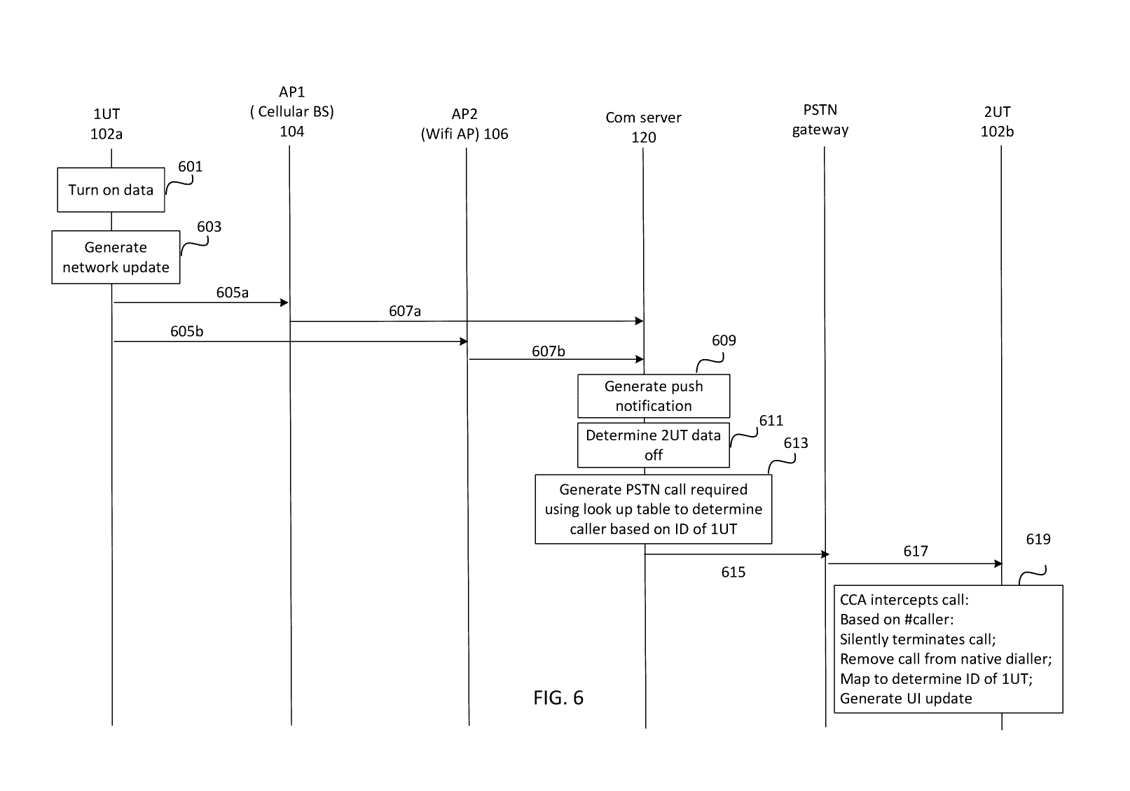

With respect to FIG. 6 an example of network characteristic presence status information communication over a PSTN network is shown. In the example shown in FIG. 6 the first user terminal and the second user terminal both are shown with their data connections switched off.

The first user terminal 1UT 102a is then shown switching on their data connection.

The operation of switching on the first user terminal 102a data connection is shown in FIG. 6 by step 601.

The first user terminal 1UT 102a may then furthermore generate a network characteristic presence status update message.

The operation of generating a network characteristic presence status update message is shown in FIG. 6 by step 603.

The network characteristic presence status update message may be communicated to the communications server 120 via any suitable network.

For example in FIG. 6 the network characteristic presence status update message may be received by the first network access point AP1 (a cellular network base station 104) which then forwards the message to the communications server 120.

The operation of transferring the network characteristic presence status update message to the first network access point AP1 (a cellular network base station 104) is shown in FIG. 6 by step 605a.

The operation of forwarding the network characteristic presence status update message to the communications server 120 from the cellular base station is shown in FIG. 6 by step 607a.

The network characteristic presence status update message may furthermore be received by the second network access point AP2 (a WiFi Access point 106) which then forwards the message to the communications server 120.

The operation of transferring the network characteristic presence status update message to the second network access point AP2 (a WiFi AP 106) is shown in FIG. 6 by step 605b.

The operation of forwarding the network characteristic presence status update message to the communications server 120 from the WiFi AP 106 is shown in FIG. 6 by step 607b.

The communications server 120, having received the network characteristic presence status update message may then be configured to generate a push message to be transmitted to a determined or selected list of further user terminals to inform the other user terminals that the user terminal is now connected to a data network.

The operation of generating a network characteristic presence status push message is shown in FIG. 6 by step 609.

In the example shown in FIG. 6 one of the addresses from the determined list of further user terminals, the second user terminal 2UT 102b, is not connected to a data network and as such is not able to receive the push message in its current form. The determination that the further user terminal is not connected to a data network may be found from network characteristic presence information associated with the second user terminal 102b. In other words a network characteristic presence service may be aware that the second user terminal 102b does not or probably does not have data switched on based on a presence keep alive timeout.

The operation of determining the second user terminal 102b is not connected to the data network is shown in FIG. 6 by step 611.

The communications server 120, having determined that the second user terminal 102b is not connected to the data network, is configured to signal network characteristic presence change using a PSTN network rather than via push notification.

For example the communications server 120 may be configured to interrogate a mapping table and calls a PSTN gateway to place a PSTN call from a number ‘C’ to the second user terminal 102b. A number re-use algorithm may organize the mapping table in such a way as to minimize the range of ‘C’ numbers required. The same mapping table is stored and updated in the second user terminal 102b. In the example shown herein the ‘C’ number is used to identify that the first user terminal is online. However in some embodiments the ‘C’ number may identify not only the identity of the first user terminal but also comprise information on the type of network characteristic presence update. Thus for example a first ‘C’ number or set of ‘C’ numbers identifies the first user terminal is on a cellular data network and a second ‘C’ number or set of ‘C’ numbers is on a WiFi data network.

An example table is shown below where the inputs are the caller number identifying the first user terminal 102a, the callee number identifying the second user terminal 102b and the output is the mapped number output. In the example shown herein the mapped number is based only one the called number.

| Caller number | Callee number | Mapped number |
|---|---|---|
| A₁ | B₁ | C₁ |
| A₂ | B₁ | C₂ |
| A₃ | B₁ | C₃ |
| A₁ | B₂ | C₁ |
| A₂ | B₂ | C₂ |
| A₃ | B₂ | C₃ |

The operation of generating a PSTN call request using a look up table to determine a mapped number based on the identity of the caller (the first user terminal) is shown in FIG. 6 by step 613.

The operation of placing a call request to the PSTN gateway is shown in FIG. 6 by step 615.

The operation of placing the call by the PSTN gateway to the callee number is shown in FIG. 6 by step 617.

The second user terminal 2UT 102b receives the call. In some embodiments the client communication application on the second user terminal is configured to intercept the call. The call ‘C’ number is then compared against a copy of the look up table and where the number produces a hit, in other words based on the ‘C’ number, silently terminate the call and remove the call from the native call register (making it a silent call).

Furthermore the ‘C’ number is mapped to the caller identifier ‘A’ number using a copy of the look up table stored on the second user terminal. Having identified the identity of the first user terminal the second user terminal may be configured to generate a network characteristic presence interrupt message such as shown in FIG. 4, so that the user terminal may signal that the user A operating the first user terminal is available for a call over the data network.

In some embodiments the network characteristic presence interrupt message may present the user B operating the second user terminal 102b an option to turn on data to check the full network characteristic presence information associated with user A (rather than just whether the user terminal is data connected or not) in order to identify whether the first user terminal is accessing data via a cellular or WiFi network. In some embodiments the option to turn on data is just for the duration of the call with the first user terminal.

The operation of receiving the call and processing the call based on the ‘C’ number so to silently terminate call, remove the call from the dialler or client communication application, map the received number to determine the identity of the first user terminal, and generate the user interface update is shown in FIG. 6 by step 614.

In the example shown above the communications server 120 is configured to place the call over the PSTN network when the user terminal connects to a data network. In some embodiments the communications server 120 is configured to place the call over the PSTN network only when the user terminal connects to a specific data network, for example a WiFi network with data cost. In other words the communications server may be configured to filter the network characteristic presence status information passed over the PSTN network.

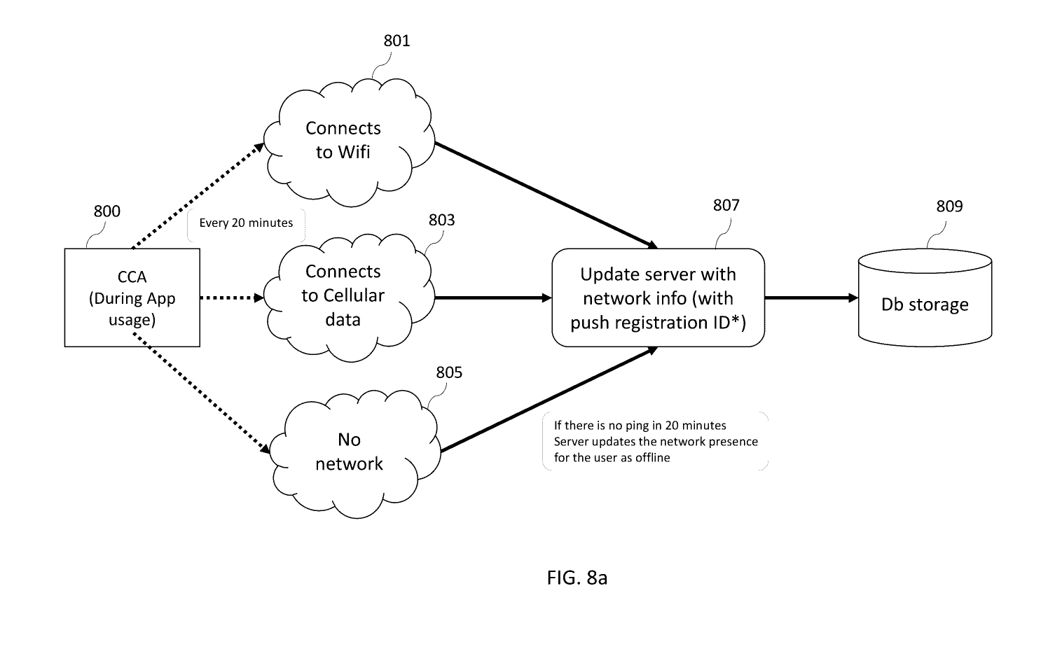

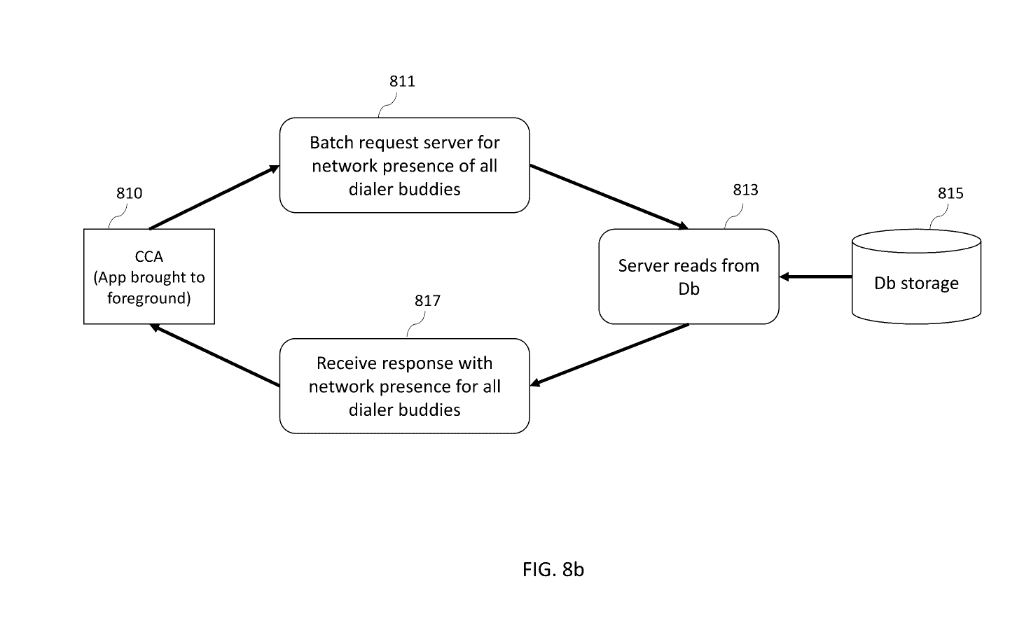

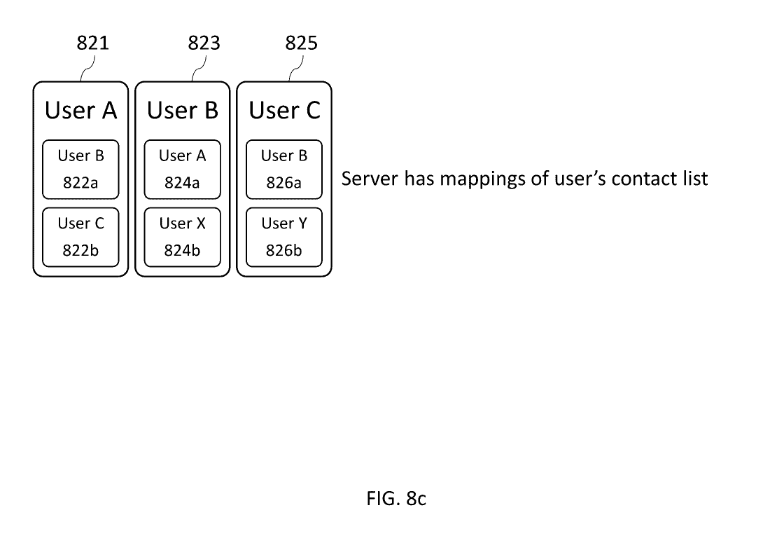

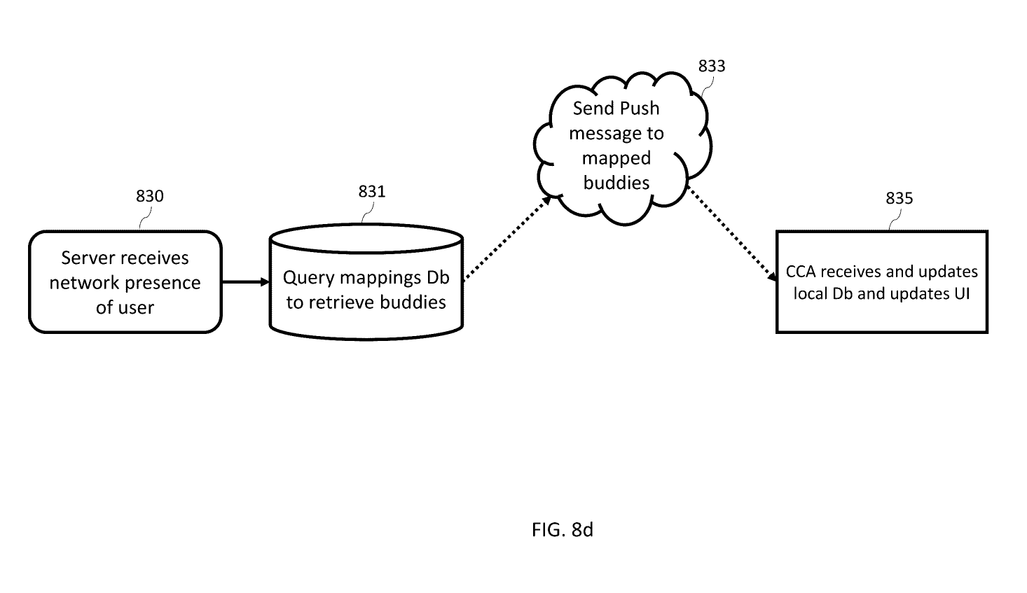

With respect to FIG. 8a a summary of network characteristic presence information control and management operations, with respect to the updating of network characteristic presence information is shown.

The communication client application (CCA) during the application usage may in some embodiments be configured to generate and transmit to the communications server network characteristic presence information. In the example shown herein the CCA may generate every 20 minutes a network characteristic presence status update message. This is shown in FIG. 8a by reference 800.

The network characteristic presence status update message may for example comprise information that the user terminal is able to communicate or connect via a WiFi network. This is shown in FIG. 8a by reference 801.

In some situations the network characteristic presence status update message may for example comprise information that the user terminal is able to communicate or connect via a cellular network. This is shown in FIG. 8a by reference 803.

Furthermore the user terminal may be unable to communicate or connect to any data network. This will result in the network characteristic presence status update message not being sent to the communications server (or in other words an absence of a network characteristic presence status update message being detected at the communications server). This is shown in FIG. 8a by reference 805.

The communications server having received the network characteristic presence status update message (or the absence of a network characteristic presence status update message within a determined period) may be configured to update the server with network characteristic presence information associated with the user terminal with a determined push registration identity.

The updating the communications server based on the network characteristic presence status update message, or absence thereof is shown in FIG. 8a by reference 807.

The updated network characteristic presence information associated with the determined push registration identity may then be passed to a database storage or other memory to be stored.

The storing of the updated network characteristic presence information is shown in FIG. 8a by reference 809.

With respect to the examples presented above the communications server is configured to respond to received network characteristic presence messages from a user terminal, generate push messages comprising the network characteristic presence information of the user terminal, and transmit the push messages to other user terminals based on a determined selection criteria. In some embodiments the communications server may alternatively or also be configured to respond to requests for network characteristic presence information from user terminals.

With respect to FIG. 8b a summary of network characteristic presence information control and management operations, with respect to generating and responding to a request for network characteristic presence information is shown.

In some embodiments a user terminal and the communication client application (CCA) on the user terminal during the application usage may be configured to generate and transmit to the communications server a request for network characteristic presence information. In the example shown herein the CCA may generate such a request when the CCA is brought to the foreground or activated.

The activation or bringing of the application to the foreground is shown in FIG. 8b by reference 810.

The request for network characteristic presence information may comprise a defined list or batch of other client communication application users known to the user. For example the list may be the dialler buddies of the user, or members of the recently called list, favourites list or contacts list.

The generation of the request and the transmission of the request to the communications server is shown in FIG. 8b by reference 811.

The communications server, having received the request, is configured to process the request. For example in some embodiments the communications server is configured to request network characteristic presence information from the database storage.

The processing of the request, and requesting the network characteristic presence information (for the selected list of user terminals) from the database storage is shown in FIG. 8b by reference 813.

The database storage may respond or return the network characteristic presence information to the server.

The database storage responding or returning the network characteristic presence information is shown in FIG. 8b by reference 815.

The communications server may then generate a response for the user terminal CCA. The response may comprise the returned network characteristic presence information (associated with the selected list of user terminals such as the dialler buddy list).

The generation and transmission of a response from the communications server to the user terminal and the CCA is shown in FIG. 8b by reference 817.

The response, having been received by the user terminal (and the CCA), may be processed. For example the CCA may generate an interrupt message to the user interface to display to the user any updates to the network characteristic presence information based on the response network characteristic presence information.

With respect to FIG. 8c an example of stored selection lists for network characteristic presence information transmission (push) operations is shown.

In the example shown there are records 821, 823 and 825 associated with three users User A, User B and User C respectively. Each of the records 821, 823 and 825 comprise a list of the users which will receive network characteristic presence status information when the communications server receives a network characteristic presence status update message from a user terminal associated with the user record. Thus for example the first record 821 associated with User A comprises a list of items item:UserB 822a and item:UserC 822b. In other words a network characteristic presence status update message from the user terminal associated with user A generates push messages for the user terminal associated with User B and the user terminal associated with User C. The second record 823 associated with User B comprises a list of items item:User A 824a and item:UserX 824b. In other words a network characteristic presence status update message from the user terminal associated with User B generates push messages for the user terminal associated with User A and the user terminal associated with User X. The third record 825 associated with User C comprises a list of items item:User B 826a and item:UserY 826b. In other words a network characteristic presence status update message from the user terminal associated with User C generates push messages for the user terminal associated with User B and the user terminal associated with User Y.

With respect to FIG. 8d is shown a summary of network characteristic presence information control and management operations, with respect to use of the records shown in FIG. 8c.

Thus for example the communications server is configured to receive the network characteristic presence status update message of a user from an associated user terminal.

The receipt of the network characteristic presence status update message is shown in FIG. 8d by reference 830.

The communications server may be configure to query (or interrogate) a mappings database such as shown in FIG. 8c in order to return the selected list of user terminals, for example the dialler buddies list of items stored and associated with a user.

The querying of the mappings database to retrieve the selected list is shown in FIG. 8d by reference 831.

The communications server may then generate and send the push message comprising the network characteristic presence status information to the selected list, for example the mapped buddy list shown in FIG. 8d.

The generation and sending the push message comprising the network characteristic presence status information to the selected list of user terminals is shown in FIG. 8d by reference 833.

The CCA on the user terminal receiving the push message may then process the message. For example to update a local database of network characteristic presence status information and to update the user interface (for example by generating an interrupt message).

The receipt and processing of the push message by the CCA is shown in FIG. 8d by reference 835.

Generally, any of the functions described herein can be implemented using software, firmware, hardware (e.g., fixed logic circuitry), or a combination of these implementations. The terms “controller”, “functionality”, “component”, and “application” as used herein generally represent software, firmware, hardware, or a combination thereof. In the case of a software implementation, the controller, functionality, component or application represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

According to a first aspect there is a communications server, the communications server comprising a network characteristic presence service application for managing and communicating network characteristic presence status information with at least one user terminal, the network characteristic presence service application being configured to: determine network characteristic presence status information associated with a first user terminal based on the receipt or absence of a network characteristic presence status update message; and communicate the network characteristic presence status information associated with a first user terminal to at least one further user terminal, such that the at least one further user terminal indicates the current network characteristic presence status associated with the first user terminal.

The network characteristic presence service application configured to communicate the network characteristic presence status information may be configured to determine at least one further user terminal from a list of further user terminals associated with the first user terminal to which to communicate the network characteristic presence update status information.

The list of further user terminals may be one of: a call history user terminal list associated with the first user terminal; a favourites user terminal list associated with the first user terminal; a dialler buddy user terminal list associated with the first user terminal; a speed dial user terminal list associated with the first user terminal; and a contacts user terminal list associated with the first user terminal.

The network characteristic presence service application configured to communicate the network characteristic presence status information associated with a first user terminal may be configured to: generate a push message comprising the network characteristic presence status information; and transmit the push message to the at least one further user terminal, such that the at least one further user terminal receives and processes the push message to indicate the current network characteristic presence status associated with the first user terminal.

The network characteristic presence service application configured to communicate the network characteristic presence status information associated with a first user terminal may be configured to: determine the at least one further user terminal is absent from an access data network; determine a caller number based on a first user terminal identity and the network characteristic presence status; and generate and place a PSTN call using the determined caller number, such that the at least one further user terminal receives and identifies from the caller number the first user terminal identity and the network characteristic presence status.

The network characteristic presence service application configured to communicate the network characteristic presence status information associated with a first user terminal may be configured to: receive a network characteristic presence status request from the at least one further user terminal; generate a network characteristic presence status response message comprising the network characteristic presence update status information; and transmit the network characteristic presence status response message to the at least one further user terminal, such that the at least one further user terminal receives and processes the network characteristic presence status response message to indicate the current network characteristic presence status associated with the first user terminal.

The network characteristic presence service application configured to determine network characteristic presence status information associated with the first user terminal may be configured to: receive a network characteristic presence status update message, the message identifying an access data network associated with the first user terminal; and store as the network characteristic presence status information the identity of the access data network associated with the first user terminal.

The network presence service application configured to determine network presence status information associated with the first user terminal may be configured to: determine over a defined period an absence of received network presence status update messages from the first user terminal; and store as the network characteristic presence status information the first user terminal is absent from an access data network.

According to a further aspect there is provided a user terminal, the user terminal comprising a communication client application for managing and communicating network characteristic presence status information with at least one further user terminal, the communication client application being configured to: generate a network characteristic presence status update message comprising a user terminal access data network identity as network characteristic presence status information associated with the user terminal; transmit the network characteristic presence status update message to a communications server such that the communications server is configured to communicate the network characteristic presence status information associated with the user terminal to at least one further user terminal.

The communication client application may be further configured to generate the network characteristic presence update status message based on at least one of: a determination of a change in the access data network associated with the user terminal; a determined time period expiring; and a determination of a change of quality in the access data network associated with the user terminal.

The network characteristic presence status update message may further comprise a selection of further user terminals to which the communications server is configured to communicate the network characteristic presence status information associated with the user terminal.

According to another aspect there is provided a user terminal, the user terminal comprising a communication client application for managing and communicating network characteristic presence status information from at least one further user terminal, the communication client application being configured to: receive presence status information associated with at least one further user terminal; and generate an interrupt message based on the presence status information so to indicate the current network characteristic presence status associated with the at least one further user terminal.

The user terminal may further comprise a user interface configured to: receive the interrupt message; and generate and display a user interface window based on the interrupt message so to indicate the current network characteristic presence status associated with the first user terminal.

The user interface may be further configured to determine a user input associated with a user interface element within the user interface window, the user interface element indicating the user terminal can place a call between the user terminal and the further user terminal using a defined access network associated with the further user terminal.

The communication client application based on the receiving of the user input may be configured to place a call between the user terminal and the further user terminal using the defined access network associated with the further user terminal.

The communication client application may be further configured to: generate a network characteristic presence status request; transmit the network characteristic presence status request to the communication server; and receive as a response to the network characteristic presence status request the presence status information associated with at least one further user terminal from the communication server.

A communications system may comprise: a communications server as discussed herein; a user terminal as discussed herein; and a further user terminal as discussed herein.

According to a further aspect there is provided a method for managing and communicating network characteristic presence status information between user terminals, the method comprising: determining network characteristic presence status information associated with a first user terminal based on the receipt or absence of a network characteristic presence status update message; and communicating the network characteristic presence status information associated with a first user terminal to at least one further user terminal, such that the at least one further user terminal indicates the current network characteristic presence status associated with the first user terminal.

Communicating the network characteristic presence status information may comprise determining at least one further user terminal from a list of further user terminals associated with the first user terminal to which to communicate the network characteristic presence update status information.

The list of further user terminals may be one of: a call history user terminal list associated with the first user terminal; a favourites user terminal list associated with the first user terminal; a dialler buddy user terminal list associated with the first user terminal; a speed dial user terminal list associated with the first user terminal; and a contacts user terminal list associated with the first user terminal.

Communicating the network characteristic presence status information associated with a first user terminal may comprise: generating a push message comprising the network characteristic presence status information; and transmitting the push message to the at least one further user terminal, such that the at least one further user terminal receives and processes the push message to indicate the current network characteristic presence status associated with the first user terminal.

Communicating the network characteristic presence status information associated with a first user terminal may comprise: determining the at least one further user terminal is absent from an access data network; determining a caller number based on a first user terminal identity and the network characteristic presence status; and generating and placing a PSTN call using the determined caller number, such that the at least one further user terminal receives and identifies from the caller number the first user terminal identity and the network characteristic presence status.

Communicating the network characteristic presence status information associated with a first user terminal may comprise: receiving a network characteristic presence status request from the at least one further user terminal; generating a network characteristic presence status response message comprising the network characteristic presence update status information; and transmitting the network characteristic presence status response message to the at least one further user terminal, such that the at least one further user terminal receives and processes the network characteristic presence status response message to indicate the current network characteristic presence status associated with the first user terminal.

Determining network characteristic presence status information associated with the first user terminal may comprise: receiving a network characteristic presence status update message, the message identifying an access data network associated with the first user terminal; and storing as the network characteristic presence status information the identity of the access data network associated with the first user terminal.

Determining network presence status information associated with the first user terminal may comprise: determining over a defined period an absence of received network presence status update messages from the first user terminal; and storing as the network characteristic presence status information the first user terminal is absent from an access data network.

According to another aspect there is provided a method for managing and communicating network characteristic presence status information between user terminals, the method comprising: generating a network characteristic presence status update message comprising a user terminal access data network identity as network characteristic presence status information associated with the user terminal; and transmitting the network characteristic presence status update message, wherein the message is configured to communicate the network characteristic presence status information associated with the user terminal to at least one further user terminal.

The method may further comprise generating the network characteristic presence update status message based on at least one of: a determination of a change in the access data network associated with the user terminal; a determined time period expiring; and a determination of a change of quality in the access data network associated with the user terminal.

The network characteristic presence status update message may further comprise a selection of further user terminals to which the network characteristic presence status information associated with the user terminal is communicated.

According to a further aspect there is provided a method for managing and communicating network characteristic presence status information between user terminals, the method comprising: receiving at a first user terminal presence status information associated with at least one further user terminal; and generating an interrupt message based on the presence status information so to indicate the current network characteristic presence status associated with the at least one further user terminal.

The method may further comprise: receiving the interrupt message; and generating and displaying a user interface window based on the interrupt message so to indicate the current network characteristic presence status associated with the first user terminal.

The method may further comprise: determining a user input associated with a user interface element within the user interface window, the user interface element indicating the user terminal can place a call between the user terminal and the further user terminal using a defined access network associated with the further user terminal; and based on the receiving of the user input placing a call between the user terminal and the further user terminal using the defined access network associated with the further user terminal.

The method may further comprise: generating a network characteristic presence status request; transmitting the network characteristic presence status request to the communication server; and receiving as a response to the network characteristic presence status request the presence status information associated with at least one further user terminal from the communication server.

An apparatus may comprise: at least one processor; and a memory comprising communication client application code for managing communications with at least one further apparatus over a first network, the code, when executed on the at least one processor, causes the apparatus to perform the methods as discussed herein.

According to a further aspect there is provided an apparatus for managing and communicating network characteristic presence status information between user terminals, the apparatus comprising: means for determining network characteristic presence status information associated with a first user terminal based on the receipt or absence of a network characteristic presence status update message; and means for communicating the network characteristic presence status information associated with a first user terminal to at least one further user terminal, such that the at least one further user terminal indicates the current network characteristic presence status associated with the first user terminal.

The means for communicating the network characteristic presence status information may comprise means for determining at least one further user terminal from a list of further user terminals associated with the first user terminal to which to communicate the network characteristic presence update status information.

The list of further user terminals may be one of: a call history user terminal list associated with the first user terminal; a favourites user terminal list associated with the first user terminal; a dialler buddy user terminal list associated with the first user terminal; a speed dial user terminal list associated with the first user terminal; and a contacts user terminal list associated with the first user terminal.

The means for communicating the network characteristic presence status information associated with a first user terminal may comprise: means for generating a push message comprising the network characteristic presence status information; and means for transmitting the push message to the at least one further user terminal, such that the at least one further user terminal receives and processes the push message to indicate the current network characteristic presence status associated with the first user terminal.

The means for communicating the network characteristic presence status information associated with a first user terminal may comprise: means for determining the at least one further user terminal is absent from an access data network; means for determining a caller number based on a first user terminal identity and the network characteristic presence status; and means for generating and placing a PSTN call using the determined caller number, such that the at least one further user terminal receives and identifies from the caller number the first user terminal identity and the network characteristic presence status.

The means for communicating the network characteristic presence status information associated with a first user terminal may comprise: means for receiving a network characteristic presence status request from the at least one further user terminal; means for generating a network characteristic presence status response message comprising the network characteristic presence update status information; and means for transmitting the network characteristic presence status response message to the at least one further user terminal, such that the at least one further user terminal receives and processes the network characteristic presence status response message to indicate the current network characteristic presence status associated with the first user terminal.

The means for determining network characteristic presence status information associated with the first user terminal may comprise: means for receiving a network characteristic presence status update message, the message identifying an access data network associated with the first user terminal; and means for storing as the network characteristic presence status information the identity of the access data network associated with the first user terminal.

The means for determining network presence status information associated with the first user terminal may comprise: means for determining over a defined period an absence of received network presence status update messages from the first user terminal; and means for storing as the network characteristic presence status information the first user terminal is absent from an access data network.

According to another aspect there is provided an apparatus for managing and communicating network characteristic presence status information between user terminals, the apparatus comprising: means for generating a network characteristic presence status update message comprising a user terminal access data network identity as network characteristic presence status information associated with the user terminal; and means for transmitting the network characteristic presence status update message, wherein the message is configured to communicate the network characteristic presence status information associated with the user terminal to at least one further user terminal.

The means for generating the network characteristic presence update status message may generate the message based on at least one of: a determination of a change in the access data network associated with the user terminal; a determined time period expiring; and a determination of a change of quality in the access data network associated with the user terminal.

The network characteristic presence status update message may further comprise a selection of further user terminals to which the network characteristic presence status information associated with the user terminal is communicated.

According to a further aspect there is provided an apparatus for managing and communicating network characteristic presence status information between user terminals, the apparatus comprising: means for receiving at a first user terminal presence status information associated with at least one further user terminal; and means for generating an interrupt message based on the presence status information so to indicate the current network characteristic presence status associated with the at least one further user terminal.

The apparatus may further comprise: means for receiving the interrupt message; and means for generating and displaying a user interface window based on the interrupt message so to indicate the current network characteristic presence status associated with the first user terminal.

The apparatus may further comprise: means for determining a user input associated with a user interface element within the user interface window, the user interface element indicating the user terminal can place a call between the user terminal and the further user terminal using a defined access network associated with the further user terminal; and based on the receiving of the user input placing a call between the user terminal and the further user terminal using the defined access network associated with the further user terminal.

The apparatus may further comprise: means for generating a network characteristic presence status request; means for transmitting the network characteristic presence status request to the communication server; and means for receiving as a response to the network characteristic presence status request the presence status information associated with at least one further user terminal from the communication server.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A communications server comprising:
a network characteristic presence service application for managing and communicating network characteristic presence status information with at least one user terminal, the network characteristic presence service application being executable by the communications server to perform operations including:
determining network characteristic presence status information associated with a first user terminal based on the receipt or absence of a network characteristic presence status update message; and
communicating the network characteristic presence status information associated with a first user terminal to at least one further user terminal, such that the at least one further user terminal indicates the current network characteristic presence status associated with the first user terminal.

2. The communications server according to claim 1, wherein the operations further include determining at least one further user terminal from a list of further user terminals associated with the first user terminal to which to communicate the network characteristic presence update status information.

3. The communications server according to claim 2, wherein the list of further user terminals comprises at least one of:
a call history user terminal list associated with the first user terminal;
a favourites user terminal list associated with the first user terminal;
a dialler buddy user terminal list associated with the first user terminal;
a speed dial user terminal list associated with the first user terminal; or
a contacts user terminal list associated with the first user terminal.

4. The communications server according to claim 1, wherein the operations further include:
generating a push message comprising the network characteristic presence status information; and
transmitting the push message to the at least one further user terminal, such that the at least one further user terminal receives and processes the push message to indicate the current network characteristic presence status associated with the first user terminal.

5. The communications server according to claim 1, wherein the operations further include:
determining the at least one further user terminal is absent from an access data network;
determining a caller number based on a first user terminal identity and the network characteristic presence status; and
generating and placing a PSTN call using the determined caller number, such that the at least one further user terminal receives and identifies from the caller number the first user terminal identity and the network characteristic presence status.

6. The communications server according to claim 1, wherein the operations further include:
receiving a network characteristic presence status request from the at least one further user terminal;
generating a network characteristic presence status response message comprising the network characteristic presence update status information; and
transmitting the network characteristic presence status response message to the at least one further user terminal, such that the at least one further user terminal receives and processes the network characteristic presence status response message to indicate the current network characteristic presence status associated with the first user terminal.

7. The communications server according to claim 1, wherein the operations further include:
receiving a network characteristic presence status update message, the message identifying an access data network associated with the first user terminal; and
storing as the network characteristic presence status information the identity of the access data network associated with the first user terminal.

8. The communications server according to claim 1, wherein the operations further include:
determining over a defined period an absence of received network presence status update messages from the first user terminal; and
storing as the network characteristic presence status information the first user terminal is absent from an access data network.

9. A user terminal comprising:
a communication client application for managing and communicating network characteristic presence status information with at least one further user terminal, the communication client application being executable by the user terminal to perform operations including:
generating a network characteristic presence status update message comprising a user terminal access data network identity as network characteristic presence status information associated with the user terminal;
transmitting the network characteristic presence status update message to a communications server such that the communications server is configured to communicate the network characteristic presence status information associated with the user terminal to at least one further user terminal.

10. The user terminal according to claim 9, wherein said generating the network characteristic presence update status message is based on at least one of:
a determination of a change in the access data network associated with the user terminal;
a determined time period expiring; or
a determination of a change of quality in the access data network associated with the user terminal.

11. The user terminal according to claim 9, wherein the network characteristic presence status update message further comprises a selection of further user terminals to which the communications server is configured to communicate the network characteristic presence status information associated with the user terminal.

12. A user terminal comprising:
a communication client application for managing and communicating network characteristic presence status information from at least one further user terminal, the communication client application being executable by the user terminal to perform operations including:
receiving presence status information associated with at least one further user terminal; and
generating an interrupt message based on the presence status information so to indicate the current network characteristic presence status associated with the at least one further user terminal.

13. The user terminal according to claim 12, further comprising a user interface configured to:
receive the interrupt message; and
generate and display a user interface window based on the interrupt message so to indicate the current network characteristic presence status associated with the first user terminal.

14. The user terminal according to claim 13, wherein the user interface is further configured to:
determine a user input associated with a user interface element within the user interface window, the user interface element indicating the user terminal can place a call between the user terminal and the further user terminal using a defined access network associated with the further user terminal; wherein the communication client application based on the receiving of the user input is configured to place a call between the user terminal and the further user terminal using the defined access network associated with the further user terminal.

15. The user terminal according to claim 12, wherein the operations further include:
generating a network characteristic presence status request;
transmitting the network characteristic presence status request to the communication server; and
receiving as a response to the network characteristic presence status request the presence status information associated with at least one further user terminal from the communication server.

16. A method for managing and communicating network characteristic presence status information between user terminals, the method comprising:
determining network characteristic presence status information associated with a first user terminal based on the receipt or absence of a network characteristic presence status update message; and
communicating the network characteristic presence status information associated with a first user terminal to at least one further user terminal, such that the at least one further user terminal indicates the current network characteristic presence status associated with the first user terminal.

17. A method for managing and communicating network characteristic presence status information between user terminals, the method comprising:
generating a network characteristic presence status update message comprising a user terminal access data network identity as network characteristic presence status information associated with the user terminal; and
transmitting the network characteristic presence status update message, wherein the message is configured to communicate the network characteristic presence status information associated with the user terminal to at least one further user terminal.

18. A method for managing and communicating network characteristic presence status information between user terminals, the method comprising:
receiving at a first user terminal presence status information associated with at least one further user terminal; and
generating an interrupt message based on the presence status information so to indicate the current network characteristic presence status associated with the at least one further user terminal.

19. An apparatus comprising:
at least one processor; and
a memory comprising communication client application code for managing communications with at least one further apparatus over a first network, the code, the communication client code being executable by the at least one processor to perform operations including:
determining network characteristic presence status information associated with a first user terminal based on the receipt or absence of a network characteristic presence status update message; and
communicating the network characteristic presence status information associated with a first user terminal to at least one further user terminal, such that the at least one further user terminal indicates the current network characteristic presence status associated with the first user terminal.

20. The apparatus according to claim 19, wherein the operations further include determining at least one further user terminal from a list of further user terminals associated with the first user terminal to which to communicate the network characteristic presence update status information.
